(19) United States
(12) Patent Application Publication
(10) Pub. No.: US 2024/0202569 A1
(43) Pub. Date: Jun. 20, 2024

(54) LEARNING DEVICE, LEARNING METHOD, AND RECORDING MEDIUM

(71) Applicant: NEC Corporation, Minato-ku, Tokyo (JP)

(72) Inventor: Takuma KOGO, Tokyo (JP)

(73) Assignee: NEC Corporation, Minato-ku, Tokyo (JP)

(21) Appl. No.: 17/909,835

(22) PCT Filed: Mar. 16, 2020
(86) PCT No.: PCT/JP2020/011465

§ 371 Date: Sep. 7, 2022

(51) Int. Cl. G06N 20/00

(52) U.S. Cl. CPC G06N 20/00

(57) ABSTRACT

The learning device 800 includes a determination unit 801 determining control to be applied to the target system and difficulty to be set to the target system using observation information regarding the target system and difficulty corresponding to a way of state transition of the target system and how likely it is to be rated highly related to the contents of the control, according to the policy, a learning progress calculation unit 802 calculating learning progress of the policy using a plurality of original evaluations of states before and after transition of the target system and the determined control, according to the determined control and the determined difficulty, a calculation unit 803 calculating revised evaluation using the original evaluation, the determined difficulty, and the calculated learning progress, and a policy updating unit 804 updating the policy using the observation information, the determined control, the determined difficulty, and the revised evaluation.

### TECHNICAL FIELD

The present invention relates to a learning device and the like that learns regarding control contents and the like that control a control object, for example.

### BACKGROUND ART

Machine learning is used in various situations such as image recognition and machine control. Machine learning has attracted attention as having potential to achieve complex and advanced decision-making that is considered difficult to achieve by human design, and is being diligently developed.

Reinforcement learning has achieved decision-making beyond the human level in a system that automatically determines behavior of a computer player in a game, for example. Reinforcement learning has achieved complex behavior that is considered difficult to achieve with human design in a system that automatically determines behavior of a robotic system.

The framework for performing reinforcement learning includes a target system itself (or an environment that simulates the target system) and an agent that determines behavior (hereafter referred to as “an action”) for the target system. In reinforcement learning, training data is a set of an action, an observation, and a reward. The reward is given, for example, according to similarity between a state of the target system and a desired state. In this case, the higher the similarity between the state of the target system and the desired state, the higher the reward. The lower the similarity between the state of the target system and the desired state, the lower the reward. The observation and the reward are acquired from the environment each time the agent performs an action. In reinforcement learning, the learning explores various acts so that the reward acquired by the action is high, while the agent does trial and error. The learning means to repetitively update a policy, which is a mathematical model that defines the action of the agent, using the training data acquired from the exploration. The policy is updated to maximize the accumulated reward that can be acquired by the series of actions from the start to the termination of the action of the agent.

In reinforcement learning, the probability of acquiring an effective reward for learning by exploration is low when both the environment and the behavior to be achieved (desired behavior) or either the environment or the behavior are complex, for example. As a result, in reinforcement learning, a huge amount of exploration is required, and the calculation time to acquire the desired policy is enormous. Therefore, research is being conducted to efficiently acquire effective rewards in reinforcement learning.

The system disclosed in patent literature 1 has a user interface that allows parameters to be changed during a learning calculation. More specifically, the system disclosed in patent literature 1 has a user interface that allows a weight coefficient of each evaluation index constituting the reward function to be changed during the learning calculation. The system alerts the user to change the weight coefficient when it detects that learning has stalled.

The system disclosed in patent literature 2 includes a calculation process that changes a parameter for the environment each time a learning calculation in reinforcement learning is executed. Specifically, the system determines whether or not to change the parameter based on the learning result, and when the determination is made to change, the parameter of the environment is adjusted by an update amount set by the user in advance.

The system described in non-patent literature 1 assumes that the parameters for the environment are sampled according to a probability distribution. The system has a teacher agent that modifies the probability distribution of the parameters of the environment for an agent (here, called student agent) of reinforcement learning. The teacher agent performs a calculation of a machine learning based on the learning status of the student agent and the corresponding parameter of the environment after performing the reinforcement learning calculation, and calculates the probability distribution for the parameter of the environment that provides a higher learning status. Specifically, the teacher agent performs a clustering calculation of the Gaussian mixture model. Then, the teacher agent updates the probability distribution for the parameter of the environment by selecting one from multiple normal distributions acquired by clustering based on the Bandit Algorithm.

### CITATION LIST

### Patent Literature

PTL 1: International Publication No. 2018/110305
PTL 2: Japanese Patent Laid-Open No. 2019-219741

### Non Patent Literature

NPL 1: R. Portelas, et al., “Teacher Algorithms for Curriculum Learning of Deep RL in Continuously Parametrized Environments”, In 3rd Annual Conference on Robot Learning (CoRL), 2019

### SUMMARY OF INVENTION

### Technical Problem

However, even if the techniques described in patent literatures 1 and 2 are used, it is difficult to set a parameter appropriately so that reinforcement learning can be performed efficiently. The reason for this is that the method for setting a parameter appropriately has not been established.

One of the purposes of the present invention is to provide learning devices and the like that enable efficient learning.

### Solution to Problem

As one aspect of the invention, the learning device is a learning device learning a policy that determines control contents of a target system, and includes determination means for determining control to be applied to the target system and difficulty to be set to the target system using observation information regarding the target system and difficulty corresponding to a way of state transition of the target system and how likely it is to be rated highly related to the contents of the control, according to the policy, learning progress calculation means for calculating learning progress of the policy using a plurality of original evaluations of states before and after transition of the target system and the determined control, according to the determined control and the determined difficulty, calculation means for calculating revised evaluation using the original evaluation, the determined difficulty, and the calculated learning progress, and policy updating means for updating the policy using the observation information, the determined control, the determined difficulty, and the revised evaluation.

As another aspect of the invention, the learning method is a method learning, by a computer, a policy for determining control of a target system, and includes determining control to be applied to the target system and difficulty to be set to the target system using observation information regarding the target system and difficulty corresponding to a way of state transition of the target system and how likely it is to be rated highly related to the contents of the control, according to the policy, calculating learning progress of the policy using a plurality of original evaluations of states before and after transition of the target system and the determined control, according to the determined control and the determined difficulty, calculating revised evaluation using the original evaluation, the determined difficulty, and the calculated learning progress, and updating the policy using the observation information, the determined control, the determined difficulty, and the revised evaluation.

As yet another aspect of the invention, the learning program is a program for learning a policy that determines control contents of a target system, and causes a computer to execute a process of determining control to be applied to the target system and difficulty to be set to the target system using observation information regarding the target system and difficulty corresponding to a way of state transition of the target system and how likely it is to be rated highly related to the contents of the control, according to the policy, a process of calculating learning progress of the policy using a plurality of original evaluations of states before and after transition of the target system and the determined control, according to the determined control and the determined difficulty, a process of calculating revised evaluation using the original evaluation, the determined difficulty, and the calculated learning progress, and a process of updating the policy using the observation information, the determined control, the determined difficulty, and the revised evaluation.

### Advantageous Effects of Invention

According to the present invention, efficient learning is possible.

### BRIEF DESCRIPTION OF DRAWINGS

FIG. 1 It depicts a schematic block diagram showing an example of the device configuration of the learning system of the first example embodiment.

FIG. 2 It depicts a schematic block diagram showing the functional configuration of reinforcement learning.

FIG. 3 It depicts a schematic block diagram showing process contents of learning in the first example embodiment.

FIG. 4 It depicts a flowchart showing an example of the processing flow of learning in the first example embodiment.

FIG. 5 It depicts a flowchart showing an example of the process of acquiring training data in the first example embodiment.

FIG. 6 It depicts a diagram showing an example of an adjustment function in the first example embodiment.

FIG. 7 It depicts a block diagram showing the main part of the learning device.

### EXAMPLE EMBODIMENTS

First, to facilitate understanding of the present invention, the problem to be solved by the present invention will be explained in detail.

The inventor of the present invention found a problem in the techniques described in patent literature 1 and patent literature 2 with regard to setting a parameter by a user in detail according to learning status. In other words, although the technique receives a parameter from the user for example, the inventor found a problem that the user cannot set a parameter appropriately. In the technique, for example, when the user fails to set a parameter appropriately, the learning efficiency is reduced.

Further, the inventor of the present invention also found that in the systems described in patent literatures 1 and 2, the parameter cannot be updated until the next learning calculation, once the parameter is determined, because the parameter is updated every time learning calculation is done. In other words, in the system, when an inappropriate parameter is set, the exploration for the action of the agent is executed without being able to change the parameter in the middle of the exploration. As a result, even if the agent does not acquire a reward that is effective for learning, it waits until the next learning calculation to change the parameter, therefore the learning efficiency is reduced.

The inventor has found those problems and has come up with a means to solve them.

Next, an overview of curriculum learning used in this description will be explained. Curriculum learning is a method based on the learning process of learning easy tasks and then learning difficult tasks. A low difficulty task represents, for example, a task with a high probability of success or a high expected value of achievement. A high difficulty task represents, for example, a task that achieves a desired state or desired control. By applying this type of curriculum learning to reinforcement learning, the training data acquired under the less difficult condition in reinforcement learning has a higher probability of containing reward that is effective for learning. Therefore, by using the policy updated with this training data, the probability that the training data to be acquired also under the higher difficult contains effective reward for learning becomes higher, and the efficiency of learning can be improved.

Next, example embodiments of the present invention will be explained in detail with reference to the drawings, however the following example embodiments are not limiting to the claimed invention. In addition, not all of the combinations of features explained in the example embodiments are necessarily essential to the solution of the invention.

### First Example Embodiment

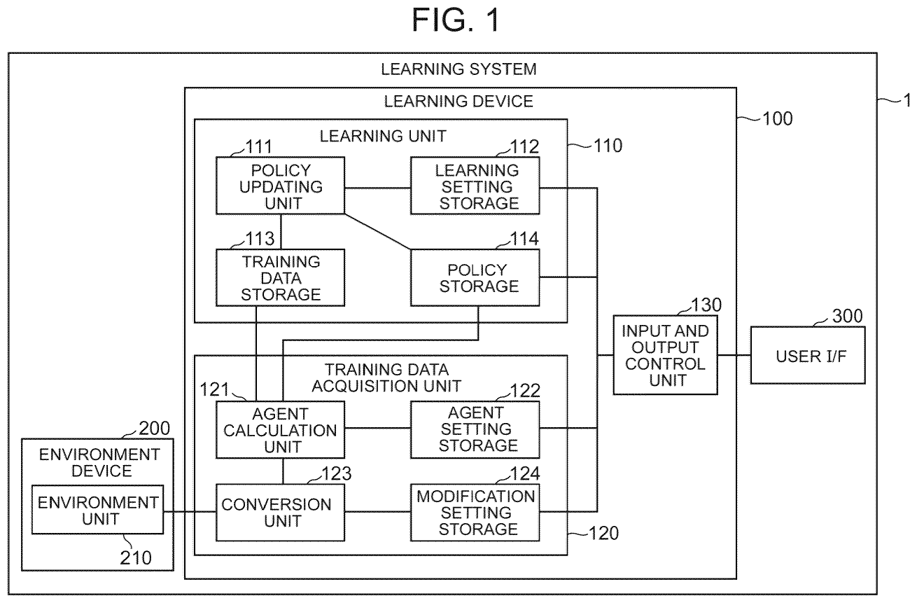

With reference to FIG. 1, an example of the configuration of the learning system 1 including the learning device 100 of the first example embodiment of the present invention will be explained in detail. FIG. 1 is a schematic block diagram showing the configuration of the learning system 1 including the learning device 100 of the first example embodiment of the present invention.

The learning system 1 roughly has a learning device 100, an environment device 200, and a user interface (hereinafter, referred to as “I/F”) 300. The learning device 100 has a learning unit 110, a training data acquisition unit 120, and an input and output control unit 130. The learning unit 110 has a policy updating unit 111, a learning setting storage 112, a training data storage 113, and a policy storage 114. The training data acquisition unit 120 has an agent calculation unit 121, an agent setting storage 122, a conversion unit 123, and a modification setting storage 124. The environment device 200 has an environment unit 210. The environment unit 210 executes the processing of the environment device 200.

The learning device 100 is communicatively connected to the environment device 200 and the user I/F 300 through a communication line. As the communication line, for example, a leased line, the internet, a VPN (Virtual Private Network), a LAN (Local Area Network), a USB (Universal Serial Bus), a Wi-Fi (registered trademark) Blue Tooth (registered trademark) or the like may be used, regardless of the occupation form and the physical form of the communication line, such as a wired or wireless line.

The learning device 100 generates a policy for determining the control contents to make the target system, such as a control object, operate as desired, according to the learning process as described below: In other words, the learning device 100 generates a policy that achieves processing as a controller controlling a target system. Thus, for example, a user can design and implement a controller controlling the target system by generating a policy using the learning device 100.

Here, the target system is a system that is the object of control. The target system is a system that controls individual devices that make up the system, such as a robot system, for example. The target system may be a system that controls objects or instances in a program, such as a game system, for example. However, the target system is not limited to these examples. The control in a robot system is, for example, angular velocity control or torque control of each joint of an arm-type robot. Alternatively, the control may be, for example, motor control of each module of a humanoid robot. The control may be, for example, rotor control of a flying-type robot. The control in a game system may be, for example, automatic operation of a computer player and adjustment of game difficulty. Although some examples of control are given, the control is not limited to these examples.

The environment device 200 is a target system or a simulated system that simulates the target system. The simulation system is, for example, a hardware emulator, software emulator, hardware simulator, software simulator, etc. of the target system. The simulation system is not limited to these examples. A more specific examples include an example where the target system is an arm-type robot and the control is pick-and-place (a series of control tasks where an end effector attached to the end of the arm-type robot approaches an object, grasps the object, and then transports the object to a predetermined location). The simulated system is, for example, performs a software simulation in which CAD (Computer Aided Design) data of an arm-type robot is combined with a physics engine which is software capable of performing numerical calculations of dynamics. The calculation on a software emulation and a software simulation is performed on a computer, such as a personal computer (PC) or workstation.

The configuration of the learning system 1 is not limited to the configuration shown in FIG. 1. The learning device 100 may include the environment unit 210. Specifically, when using a system that simulates the target system and also uses a software emulator or a software simulator, the learning device 100 may have the environment unit 210 that executes processing related to the software emulator or the software simulator.

The user I/F 300 receives operations of setting of the learning device 100, executing a learning process, a policy export, etc. from the outside. The user I/F 300 is, for example, a personal computer, workstation, tablet, smartphone, or the like. The user I/F 300 may be an input device such as a keyboard, mouse, touch panel display, etc. However, the user I/F 300 is not limited to these examples.

The input and output control unit 130 receives operation instructions of setting the learning device 100, executing a learning process, exporting a policy, etc. via the user I/F 300 from outside. The input and output control unit 130 issues operation instructions to the learning setting storage 112, the policy storage 114, the agent setting storage 122 and the modification setting storage 124, etc. according to operation instructions received from the user I/F 300.

The learning setting storage 112 stores the setting regarding the policy learning in the policy updating unit 111 according to the operation instructions received from the input and output control unit 130. The learning setting is, for example, a hyper-parameter related to learning. When updating a policy, the policy updating unit 111 reads the setting regarding the policy learning from the learning setting storage 112.

The agent setting storage 122 stores the setting regarding the training data acquisition process in the agent calculation unit 121, according to the operation instructions received from the input and output control unit 130. The setting regarding the training data storage process is, for example, a hyper-parameter related to the training data acquisition process. When acquiring the training data, the agent calculation unit 121 reads the setting regarding the training data acquisition process from the agent setting storage 122.

The modification setting storage 124 stores the setting regarding the modification process in the conversion unit 123 according to the operation instructions received from the input and output control unit 130. The setting regarding the modification process is, for example, a hyperparameter related to the modification process. When acquiring the training data, the conversion unit 123 reads the setting regarding the modification process from the modification setting storage 124.

The learning device 100 communicates with the environment device 200 in accordance with the setting input by the user through the user I/F 300 and executes the learning calculation process using the training data acquired through the communication. As a result, the learning device 100 generates a policy: The learning device 100 is realized by a computer, such as a personal computer, workstation, etc., for example.

The policy is a parameterized model with high approximation ability. The policy is capable of calculating model parameters by the learning calculation. The policy is realized using a learnable model, such as a neural network, for example. The policy is not limited to this.

In the following, it is assumed that the policy is realized using a neural network.

Inputs to a policy are observations that can be measured regarding the target system. For example, when the target system is an arm-type robot, the inputs to the policy are the angles of each joint of the robot, angular velocity of each joint, a torque of each joint, an image data of the camera attached for recognition of the surrounding environment, point cloud data acquired by LIDER (Laser Imaging Detection and Ranging), etc. The input to the policy is not limited to these examples.

The outputs from the policy include an action to the environment, i.e., control input values that can control the target system, etc. For example, when the target system is an arm-type robot, the outputs from the policy include target velocity of each joint of the robot, target angular velocity of each joint, an input torque of each joint, etc. The output from the policy is not limited to these examples.

The learning of the policy is performed according to a reinforcement learning algorithm. The reinforcement learning algorithm is, for example, a policy gradient method. More specifically, the reinforcement learning algorithm is DDPG (Deep Deterministic Policy Gradient), PPO (Proxy Policy Optimization), SAC (Soft Actor Critic) or the like. The reinforcement learning algorithm is not limited to these examples, however can be any algorithm that is capable of learning the policy that is a controller controlling the target system.

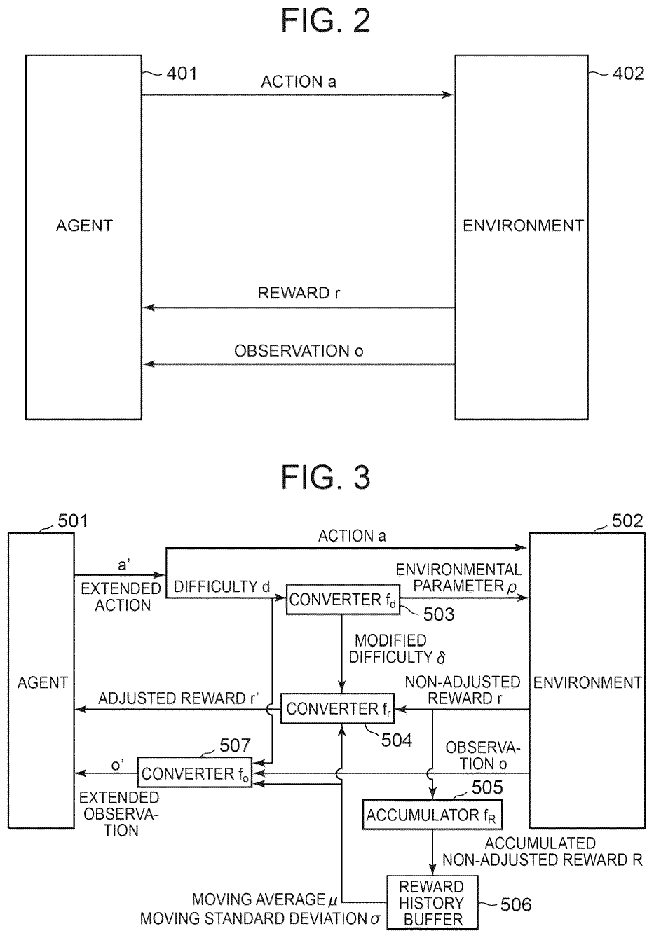

The learning process in reinforcement learning is explained with reference to FIG. 2. FIG. 2 is block diagram showing the functional configuration of reinforcement learning.

The agent 401 inputs an available observation o from the environment 402, and calculates an output with respect to the input observation o. In other words, the agent 401 calculates action a with respect to the input observation o. The agent 401 inputs the calculated action a to the environment 402.

The state of the environment 402 transitions through predetermined time steps according to the input action a. The environment 402 calculates the observation o and reward r for the state after the transition, respectively, and outputs the calculated observation o and reward r to a device such as the agent 401.

The reward r is a numerical value that represents goodness (or desirability) of the control of the action a over the state of the environment 402. The agent 401 memorizes a set of the observations o input to the policy, the action a input to the environment 402, and the rewards r output from the environment 402 as training data. In other words, the agent 401 memorizes a set of the observation o which is the basis for calculating action a, the action a, and the reward r for the action a as training data The agent 401 uses the observation o received from the environment 402 to perform processes similar to those described above, such as the process of calculating the action a.

Training data is accumulated through repeated execution of such processes. In the learning device 100, the policy updating unit 111 (shown in FIG. 1) updates the policy according to a reinforcement learning algorithm, such as the policy gradient method, using the training data, once the necessary amount of training data has been acquired. The agent 401 acquires training data according to the policy updated by the policy updating unit 111.

In reinforcement learning, the learning calculation like this and the training data acquisition process of the agent 401 (corresponding to the training data acquisition unit 120 in FIG. 1) are executed alternately or in parallel.

With reference to FIG. 3, the processing in the learning device 100 in the first example embodiment will be explained. FIG. 3 is a drawing schematically showing the process in the learning device 100 of the first example embodiment.

The learning device 100 executes the process according to the reinforcement learning method while adjusting a parameter of difficulty (hereinafter, denoted as “difficulty parameter”).

In this example embodiment, the difficulty is a numerical value or numerical values related to (or correlated with) probability of acquiring a reward in reinforcement learning method. The difficulty may be a numerical value or numerical values related to (or correlated with) an expected value of acquired reward in reinforcement learning method. The lower the difficulty, the higher the probability of acquiring a reward or the higher the expected value of the acquired reward. The higher the difficulty, the lower the probability of acquiring reward or the lower the expected value of the acquired reward. Meanwhile, the lower the difficulty, the further away from the condition of the desired environment. The higher the difficulty, the closer to the condition of the desired environment. The difficulty parameter can be said to represent, for example, a lower probability that the agent will acquire a reward, or a lower expected value of the reward that the agent will acquire. The difficulty parameter can also be a parameter related to the way of state transition of the environment.

Since the agent 501 calculates the action a and the reward d by a single process (the process of calculating the “extended action” described below) with respect to difficulty as described above, according to one common policy, it is possible to efficiently acquire training data. The reason for this is that the agent 501 determines a combination of the action and the difficulty so that the reward to be acquired is high, thus preventing the agent 501 from not acquiring the reward due to setting the difficulty too high. In addition, compared to the method in which a fixed difficulty is set while the training data is being acquired, since the agent 501 adjusts the difficult each time the agent 501 calculates the action, the appropriate difficulty can be set in detail according to the state of the environment 502.

Furthermore, since the agent 501 adjusts the difficulty as described above according to the learning progress, it is possible to efficiently acquire training data. Here, the learning progress represents a numerical value or numerical values associated with the accumulated reward that the agent 501 is expected to acquire according to the policy at the time of training data acquisition. The larger the numerical value or numerical values, the later the learning progress is. The smaller the numerical value or numerical values, the earlier the learning progress is. For example, if the agent 501 sets a lower difficulty for the early stage of the learning progress and a higher difficulty for the late stage of the learning progress, efficient reinforcement learning can be achieved. In other words, the agent 501 can achieve efficient reinforcement learning by adjusting the difficulty according to the learning progress. The learning progress is a number or a set of numbers that is related (or linked or correlated) to the probability of the agent 501 acquiring a reward. Alternatively, the learning progress is a numerical value or numerical values that relates (or is linked or correlated) to the expected value of the reward that the agent 501 will acquire.

The difference will be explained between the reinforcement learning with difficulty adjustment function (refer to FIG. 3) and the reinforcement learning without difficulty adjustment function (refer to FIG. 2), referring to FIG. 3 and FIG. 2. The difference is that, for example, a modification is performed on the action, observation, and reward sent and received between the agent and the environment through a series of calculation processes. This modification process is performed to acquire the training data to be used when learning the policy so that the agent gradually outputs higher difficulty as the learning progress while outputting an appropriate difficulty using the policy. This is a series of calculation processes mostly involving modifying the difficulty to a numerical value that can be input into the environment, calculating a parameter corresponding to the learning progress, adjusting the reward according to the difficulty and learning progress, etc. The following is a detailed explanation of the modification process in reinforcement learning with difficulty adjustment.

The agent 501 outputs an extended action a′. Suppose that the extended action a′ is represented by a column vector, for example. In this case, the extended action a′ has as elements the action a for control to be input to the environment 502 and the difficulty d of control in the environment 502. Suppose that the action a and the difficulty d are represented using a column vector, respectively. In this case, each element of the action a is assumed to correspond to a control input for each control target in the environment 502. Suppose that each element of the difficulty d corresponds to the numerical value of each element that determines the difficulty of control in the environment 502. For example, when the target system is a pick-and-place in an arm-type robot. Then, in this case, the difficulty d corresponds to each parameter related to the difficulty of grasping, such as a friction coefficient and an elastic modulus of the object to be grasped, for example. The parameter corresponding to the difficulty d is specified by the user, for example.

The converter f_{d} 503 converts the difficulty d into an environmental parameter ρ and modified difficulty δ. The environmental parameter ρ is a parameter related to the way of state transition (transition characteristic) of the environment 502, and can be control the way of state transition of the environment 502 from the desired way of state transition to state transition that is different from the desired way of state transition, regarding the way of state transition, as described below with reference to Equation (1). Suppose that the environmental parameter ρ is represented using a column vector. In this case, each element of the environmental parameter ρ is assumed to correspond to each element of the difficulty d. The environmental parameter ρ is input to the environment 502 to change its characteristics. The characteristic is the process of state transition of the environment 502 to the input action a. Suppose that each element of the environmental parameter ρ corresponds to each parameter that determines a characteristic in the environment 502. For example, when the target system is a pick-and-place in an arm-type robot, the characteristics of the environment 502 for the parameters specified by the user, such as a friction coefficient and an elastic modulus of the object to be grasped, are changed by inputting the parameter ρ with those numerical values into the environment 502.

An example of the conversion from the difficulty d to the environmental parameter ρ by the converter f_{d} 503 can specifically be Equation (1). It is not limited to the example in Equation (1), but can also be a non-linear conversion. For example, d in Equation (1) may be replaced by (d·d).

ρ=(I−d)·ρₛₜₐᵣₜ+d·ρ_{target} (1)

Here, the symbol “·” is the Hadamard product which represents a element-wise product of the column vector. Each element of difficulty d takes a value between 0 and 1, and the larger the value, the higher the difficulty of control in the environment 502 is represented by a value of the environmental parameter ρ corresponding the element. I is a column vector which dimension is the same as it of the difficulty d, and whose respective element values are 1. ρₛₜₐᵣₜ and ρ_{target} are column vectors which dimensions are the same as it of the difficulty d. Numerical value of each element of both ρₛₜₐᵣₜ and ρ_{target} and parameters which can control the characteristic of corresponding environment 502 are set by the user, for example. ρₛₜₐᵣₜ is an environmental parameter in the environment 502 for the lowest difficulty case (for example, when d is a zero vector) that can be specified by difficulty d. Similarly, ρ_{target} is an environmental parameter in the environment 502 for the most difficult case (for example, when d is I) that can be specified by difficulty d. Typically, ρ_{target} is set by the user to be as close as possible to or consistent with the environmental parameter for the final use of the policy as a controller.

The modified difficulty δ is a column vector or scalar values that are input to the converter fᵣ 504 and are converted to a feature representing the difficulty by the converter f_{d} 503. For simplicity in the following explanation, an example of converting the modified difficulty δ to a scalar value will be explained. In this case, as an example of converting the difficulty d to the modified difficulty δ by the converter f_{d} 503, the Equation (2) can be used.

δ=∥d∥₁/dim(d) (2)

where ∥x∥₁ denotes the L1 norm of the column vector x. dim(x) denotes the dimension of the column vector x. The symbol “/” denotes a division. In other words, the modified difficulty δ represents an average of the absolute values of the elements of the difficulty d. The process of calculating the modified difficulty δ is not limited to Equation (2), as long as it is a process of calculating a numerical value that represents a characteristics of multiple numerical values such as a vector, for example. The process of calculating the modified difficulty δ may be achieved, for example, by replacing the L1 norm in Equation (1) with the L2 norm, or by using other nonlinear transformations. It may also be achieved by converting to a vector whose dimension is lower than d.

The environment 502 outputs the observation o and the reward when the action a and the environmental parameter ρ are input, the processing step proceeds and the state transitions. Here, it is assumed that the reward is the non-adjusted reward r. The non-adjusted reward r represents a reward in reinforcement learning without difficulty adjustment. Suppose that the observation o is represented by a column vector. In this case, each element of the observation o represents a numerical value of an observable parameter among the states of the environment 502.

The converter fᵣ 504 calculates the adjusted reward r′ so that the non-adjusted reward r is decreased or increased to the adjusted reward r′ according to the difficulty and the learning progress. The adjusted reward r′ represents a reward in reinforcement learning with difficulty adjustment. The converter fᵣ 504 calculates the adjusted reward r′ so that the less the difficulty, the less the decrease or the more the decrease, when the learning progress is low: Specifically, the converter fᵣ 504 takes as input the non-adjusted reward r, the modified difficulty δ and the moving average μ of the accumulated non-adjusted reward R, and calculates the adjusted reward r′. Here, the moving average μ of the accumulated non-adjusted reward R corresponds to the learning progress. An example of the converter fᵣ 504 can specifically be expressed by Equation (3).

r′=r×f_{c}(δ,μ) (3)

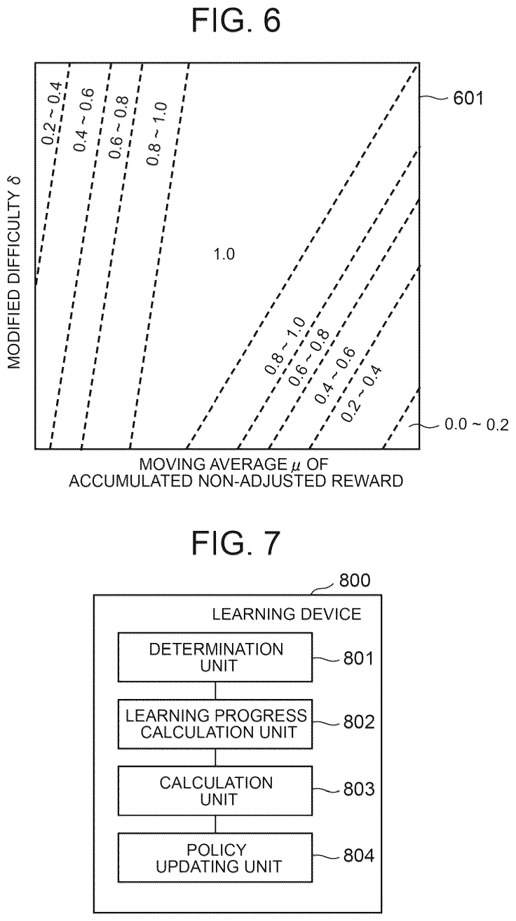

Here, the function f_{c} is a function that outputs the percentage of the non-adjusted reward r to be decreased based on the difficulty and the learning progress. It is desirable that the function f_{c} is differentiable so as to make the learning calculation of the policy more efficient. FIG. 6 shows a graph with some of the contour lines as an example of the function f_{c}. FIG. 6 is a drawing showing a graph of an example of the function f_{c} with some contour lines. As the function f_{c}, any shape defined by the user can be used. For example, It is possible to set the decrease to zero for areas of the low progress, regardless of the difficulty. It is also possible to set the percentage of decrease to be greater for areas of the higher progress as the difficulty is lower. Alternatively, the region with zero decrease can be shifted to a position with the low progress. In FIG. 6, the horizontal axis represents the moving average μ (learning progress) of the accumulated non-adjusted reward R. The higher the right side, the higher the average is, and the lower the left side, the lower the average is. The vertical axis represents the modified difficulty δ. The higher the upper side, the higher the difficulty is, and the lower the lower side, the lower the difficulty is. The values in FIG. 6 represent the values of f_{c} (δ, μ). f_{c} (δ, μ) closer to 1 represents less decreasing (or more decreasing). f_{c} (δ, μ) closer to 0, the more decreasing (or less decreasing). The converter fᵣ 504 is not limited to the example expressed in Equation (3), for example, it can be expressed in a function represented by the form of f_{c} (r, δ, μ).

The accumulator f_{R} 505 inputs the non-adjusted reward r to calculate the accumulated non-adjusted reward R. The accumulated non-adjusted reward R represents an accumulated reward in reinforcement learning without difficulty adjustment function. The accumulator f_{R} 505 calculates the accumulated non-adjusted reward R for each episode. At the start of an episode, the initial value of the accumulated non-adjusted reward R is set to 0, for example. The accumulator f_{R} 505 calculates the accumulated non-adjusted reward R by adding the non-adjusted reward r to the accumulated non-adjusted reward R each time the non-adjusted reward r is entered. In other words, the accumulator f_{R} 505 calculates the total non-adjusted reward r (accumulated non-adjusted reward R) for each episode.

An episode represents one process in which the agent 501 acquires training data through trial and error. The episode represents, for example, the process from the initial state of the environment 502 in which the agent 501 starts acquiring training data until the predetermined end condition is satisfied. The episode ends when the predetermined end condition is satisfied. When the episode ends, the environment 502 is reset to the initial state and a new episode begins.

The predetermined end condition may be, for example, a condition that the number of steps taken by the agent 501 from the start of the episode exceeds a predetermined threshold. The predetermined end condition may also be a condition such as the state where the state of the environment 502 deviates from a predetermined constraint condition due to the action a of the agent 501, etc. The predetermined end condition is not limited to these examples. The predetermined end condition may be a condition that is a combination of multiple conditions such as those described above. An example of the constraint condition is when the arm-type robot moves in on an predetermined off-limit area.

The reward history buffer 506 stores multiple accumulated non-adjusted rewards R calculated for each episode. The calculation function is assumed to be built into the reward history buffer 506, which the reward history buffer 506 uses these to calculate features corresponding to the learning progress. As the features, for example, the moving average μ and moving standard deviation σ of the accumulated non-adjusted rewards R are considered. The features corresponding to learning progress are not limited to these examples. The reward history buffer 506 samples the latest ones from among the stored multiple accumulated non-adjusted rewards R by the number of window sizes (i.e., by a predetermined number of steps) set in advance by the user, and calculates the moving average μ and moving standard deviation σ.

The converter fₒ 507 represents a process for outputting the extended observation o′ which is a column vector obtained by the combining observation o, the difficulty d, and the moving average μ and the moving standard deviation σ of the accumulated non-adjusted reward R in a column direction. Thus, the extended observation o′ includes the observation o in reinforcement learning without difficulty adjustment, the difficulty d in reinforcement learning with difficulty adjustment, and the moving average and the moving standard deviation σ in the accumulated non-adjusted reward R in reinforcement learning without difficulty adjustment. In other words, the observation o in reinforcement learning without difficulty adjustment is extended to the extended observation o′ by the addition of the difficulty and the learning progress so that the policy can output the appropriate difficulty d. By inputting the extended observation o′ to the policy: learned policy will be able to output difficulty d that is balances with the reward d acquired as the current learning progress of the policy. However, the output of the policy may be determined without explicitly considering the learning progress, in which case it is not necessary to include the learning progress in the extended observation o′.

The above is a series of calculations of the modification process in reinforcement learning with difficulty adjustment. The agent 501 sends a set of the extended action a′ and the extended observation o′ acquired by the modification process, and the adjusted reward r′ to the learning unit 110 as training data. The learning unit 110 then updates the policy using this training data. In contrast, in reinforcement learning without difficulty adjustment, the policy is updated using training data representing a set of the actions a, the observations o, and rewards r.

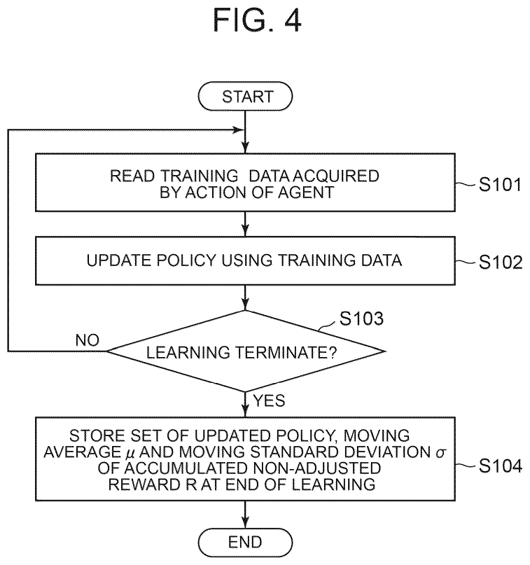

The learning unit 110 performs a calculation according to the procedure shown in FIG. 4. FIG. 4 is a flowchart showing an example of the procedure in which the learning unit 110 updates the policy using the training data acquired by the training data acquisition unit 120.

The policy updating unit 111 reads the training data group stored in the training data storage 113 acquired by the action of the agent 501 (step S101).

The policy updating unit 111 updates the policy using the read training data group (step S102). When updating, the calculation process is performed using the previously mentioned DDPG, PPO, SAC, or other algorithms. The algorithm for updating is not limited to these examples.

The policy updating unit 111 determines the terminating condition of learning (step S103). One example of the terminating condition of learning is a condition that the number of policy updates exceeds a threshold value set in advance by the user.

When the policy updating unit 111 determines that the process is not terminated (step S103: No), the process returns to step S101. When the policy updating unit 111 determines that the process is terminate (step S103: Yes), the policy updating unit 111 sends for storing a set of the updated policy, the moving average μ and the moving standard deviation σ of the accumulated non-adjusted reward R to the policy storage 114 in order to terminate the learning process (step S104).

After the process of step S104 is executed, the learning device 100 terminates the processes shown in FIG. 4.

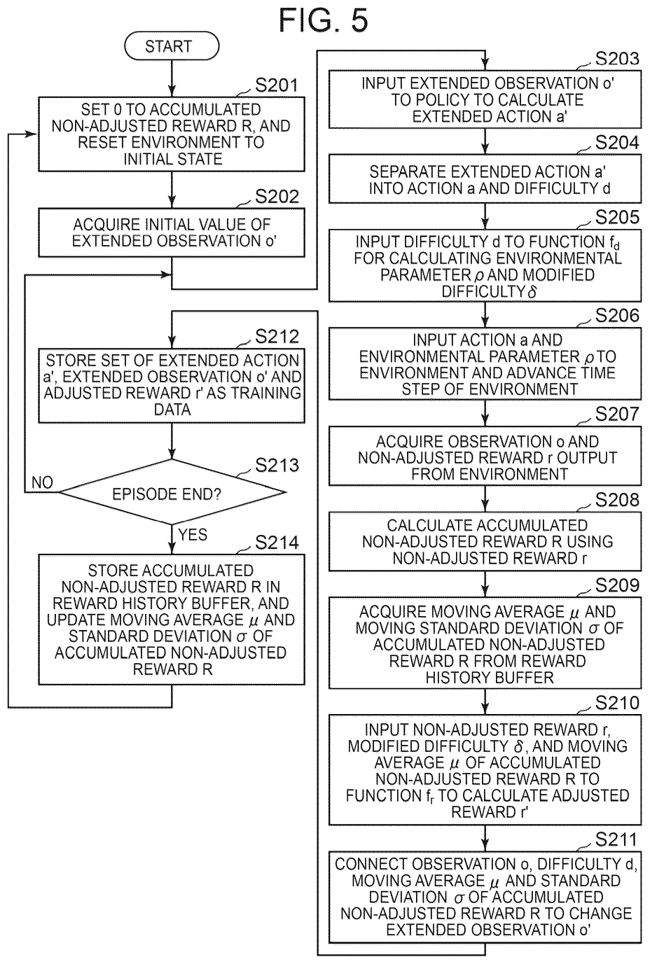

The training data acquisition unit 120 performs a calculation according to the procedure shown in FIG. 5. FIG. 5 is a flowchart showing an example of the procedure in which the training data acquisition unit 120, in cooperation with the environment device 200 and the environmental unit 210, acquires the training data used in the policy calculation. However, the procedure shown in FIG. 5 is an example. Because the flow shown in FIG. 5 includes steps that can be processed in parallel and steps that can be processed by switching the order of execution, the procedure for the calculation of the training data acquisition unit 120 is not limited to the procedure shown in FIG. 5.

The conversion unit 123 initializes the accumulated non-adjusted reward R to 0. The agent calculation unit 121 resets the environment unit 210 to the initial state and starts the episode (step S201).

The conversion unit 123 calculates an initial value of the extended observation o′ and sends it to the agent calculation unit 121 (step S202). As an example of how to calculate the initial value of extended observation o′, a calculation method, according to a process shown in the connection fₒ, uses the observation o from the environment unit 210, predefined difficulty d, and the moving average μ and the moving standard deviation σ of the accumulated non-adjusted reward R.

The agent calculation unit 121 inputs the extended observation o′ to the policy for calculating the extended action a′ (step S203). As the extended observation o′ to be input to the policy, the one acquired in the step (step S202 or step S211) immediately before step S203 immediately before step S203 is used.

The conversion unit 123 separates the extended action a′ calculated in step S204 into action a and difficulty d (step S204).

The conversion unit 123 inputs the difficulty d to the converter f_{d} for calculating the environmental parameter ρ and the modified difficulty δ (step S205).

The conversion unit 123 inputs the action a and the environmental parameter ρ to the environment unit 210 and advances the time step of the environment unit 210 to the next time step (step S206).

The conversion unit 123 acquires the observation o and the non-adjusted reward r output from the environment unit 210 (step S207).

In the conversion unit 123, the accumulator f_{R} 505 adds the non-adjusted reward r to the accumulated non-adjusted reward R (step S208). In the conversion unit 123, the converter fₒ 507 acquires the moving average μ and moving standard deviation σ of the accumulated non-adjusted reward R from the reward history buffer 506 (step S209).

In the conversion unit 123, the converter fᵣ 504 inputs the non-adjusted reward r, the modified difficulty δ, and the moving average μ of the accumulated non-adjusted reward R to calculate the adjusted reward r′ (step S210).

In conversion unit 123, the converter fₒ 507 connects the observation o, the difficulty d, the moving average μ of the accumulated non-adjusted reward, and the moving standard deviation σ of the accumulated non-adjusted reward to form the extended observation o′ (step S211).

The agent calculation unit 121 sends for storing a set of the extended action a′, the extended observation o′ and the adjusted reward r′ as the training data to the training data storage 113 (step S212).

The agent calculation unit 121 determines whether the episode has ended using the episode end condition (step S213). When the agent calculation unit 121 determines that the episode has not ended (step S213: No), the process returns to step S203. When the agent calculation unit 121 determines that the episode has ended (step S213: Yes), the conversion unit 123 stores the accumulated non-adjusted reward R in the reward history buffer 506, and calculates the moving average μ and the moving standard deviation σ to update them using the multiple accumulated non-adjusted rewards R stored in the reward history buffer 506 (step S214). When step S214 is completed, the episode ends and the process returns to step S201.

The series of processes of the training data acquisition unit 120 shown in FIG. 5 is interrupted and terminated when the series of processes of the learning unit 110 is completed.

As explained above, the learning device of this example embodiment is a learning device learning a policy that determines control contents of a target system, and comprises determination means for determining control to be applied to the target system and difficulty to be set to the target system using observation information regarding the target system and difficulty corresponding to a way of state transition of the target system and how likely it is to be rated highly related to the contents of the control, according to the policy, learning progress calculation means for calculating learning progress of the policy using a plurality of original evaluations of states before and after transition of the target system and the determined control, according to the determined control and the determined difficulty, calculation means for calculating revised evaluation using the original evaluation, the determined difficulty, and the calculated learning progress, and policy updating means for updating the policy using the observation information, the determined control, the determined difficulty, and the revised evaluation. As a result, the learning device is capable of efficient learning.

An example of a control system including the learning device 100 of the second example embodiment of the present invention will be described. In this example, the control system is an example of a target system.

The configuration of the control system is similar to that of the learning system 1. However, the environment device 200 may be configured with the policy storage 114 and the training data acquisition unit 120.

Here, the environment device 200 is a control system. The policy storage 114 stores the policy learned by the learning system 1, the moving average μ of the accumulated non-adjusted reward R, and the moving standard deviation σ of the accumulated non-adjusted reward R. The agent calculation unit 121 performs an inference calculation using the moving average μ and the moving standard deviation σ of the accumulated non-adjusted reward R stored by the policy storage 114 as input according to the policy stored by the policy storage 114.

The agent calculation unit 121 and the conversion unit 123 perform a series of calculation processes, and input the action a and the environmental parameter ρ to the environment unit 210. The environment unit 210 makes transition of the state according to the input action a and environmental parameter ρ, and outputs, for example, the observation o for the state after the transition. The conversion unit 123 converts the observation o into the extended observation o′. With the calculated extended observation o′ as input, the agent calculation unit 121, the conversion unit 123, and environment unit 210 perform the series of processes described above. This series of processes is the desired control for the control system. In other words, the agent calculation unit 121 and the conversion unit 123 determines the behavior of the control system according to the policy stored in the policy storage 114, and controls the control system to perform the determined behavior. As a result, the control system performs the desired behavior.

Here, the difficulty d acquired from the extended action of the agent calculation unit 121 is changed into I, and I is input to converter f_{d} so that the environmental parameter ρ to be input to the environment unit 210 becomes to be ρ_{target}.

For environmental parameters that cannot be changed by the environmental parameter ρ among environmental parameters to be input to the environment unit 210, setting using the environmental parameter ρ may be ignored. For example, numerical values are easy to change in simulation or emulation of friction coefficient and elastic modulus of an object, etc. or parameters whose numerical values are easy to change in simulation or emulation, however they are parameters which cannot be changed in a real system.

The converter fₒ 507 inputs the moving average μ and the moving standard deviation σ of the accumulated non-adjusted reward R stored by the policy storage 114 instead of the moving average μ and the moving standard deviation σ of the accumulated non-adjusted reward R output from the reward history buffer 506. Therefore, the conversion unit 123 does not have to perform the calculation process for the reward history buffer 506.

The conversion unit 123 may not perform respective calculations of the converter fᵣ 504 and the accumulator f_{R} 505. This is because the agent calculation unit 121 does not need to send the training data to the training data storage 113 for storage.

The above is the calculation process of the learning device 100 in the control system. As described above, the learning device 100 of the second example embodiment can make the learned policy work as a controller, as a part of the control system. The control system includes, for example, a pick-and-place control system for an arm-type robot, a gait control system for a humanoid robot, and a flight attitude control system for a flying-type robot. The control system is not limited to these examples.

The configuration of the learning device 100 is not limited to a computer-based configuration. For example, the learning device 100 may be configured using dedicated hardware, such as using an ASIC (Application Specific Integrated Circuit).

The invention can also be realized by having the CPU (Central Processing Unit) execute a computer program for any processing. It is also possible to have the program executed in conjunction with an auxiliary processing unit such as a GPU (Graphic Processing Unit) in addition to the CPU. In this case, the program can be stored using various types of non-transitory computer readable media and supplied to the computer. Non-transitory computer readable media include various types of tangible storage media. Examples of non-transient computer readable media include magnetic storage media (for example, a flexible disk, a magnetic tape, hard disk), magneto-optical storage media (for example, magneto-optical disc), CD-ROM (compact disc-read only memory), CD-R, CD-R/W, DVD (Digital Versatile Disc), BD (Blu-ray (registered trademark) Disc) and semiconductor memories (for example, mask ROM, PROM (programmable ROM), EPROM (erasable PROM), flash ROM, and RAM (Random Access Memory)).

FIG. 7 is a block diagram showing the main part of the learning device. The learning device 800 comprises a determination unit (determination means) 801 (in the example embodiments, realized by the agent calculation unit 121) which determines control (for example, action a) to be applied to the target system and difficulty (for example, difficulty δ) to be set to the target system using observation information (for example, observation o) regarding the target system and difficulty corresponding to a way of state transition of the target system and how likely it is to be rated highly related to the contents of the control, according to the policy, a learning progress calculation unit (learning progress calculation means) 802 (in the example embodiments, realized by the conversion unit 123, in particular, the accumulator f_{R} 505 and the reward history buffer 506) which calculates learning progress (for example, the moving average μ of the accumulated non-adjusted reward R) of the policy using a plurality of original evaluations (for example, non-adjusted reward r) of states before and after transition of the target system and the determined control, according to the determined control and the determined difficulty (for example, difficulty δ), a calculation unit (calculation means) 803 (in the example embodiments, realized by the conversion unit 123, in particular, the converter fᵣ 504) which calculates revised evaluation (for example, adjusted reward r′) using the original evaluation, the determined difficulty, and the calculated learning progress, and a policy updating unit (policy updating means) 804 (in the example embodiments, realized by the policy updating unit 111) which updates the policy using the observation information, the determined control, the determined difficulty, and the revised evaluation.

Although the invention of the present application has been explained above with reference to example embodiments, the present invention is not limited to the above example embodiments. Various changes can be made to the configuration and details of the present invention that can be understood by those skilled in the art within the scope of the present invention.

### REFERENCE SIGNS LIST

100 Learning device
110 Learning unit
111 Policy updating unit
112 Learning setting storage
113 Training data storage
114 Policy storage
120 Training data acquisition unit
121 Agent calculation unit
122 Agent setting storage
123 Conversion unit
124 Modification setting storage
130 Input and output control unit
200 Environment device
210 Environment unit
300 User I/F
401 Agent
402 Environment
501 Agent
502 Environment
503 Converter f_{d}
504 Conversion calculation unit fᵣ
505 Accumulation calculation unit f_{R}
506 Reward history buffer
507 Connection calculation unit fₒ
601 Adjustment function
800 Learning device
801 Determination unit
802 Learning progress calculation unit
803 Calculation unit
804 Policy updating unit

What is claimed is:

1. A learning device learning a policy that determines control contents of a target system, comprising:
a memory storing software instructions, and
one or more processors configured to execute the software instructions to
determine control to be applied to the target system and difficulty to be set to the target system using observation information regarding the target system and difficulty corresponding to a way of state transition of the target system and how likely it is to be rated highly related to the contents of the control, according to the policy;
calculate learning progress of the policy using a plurality of original evaluations of states before and after transition of the target system and the determined control, according to the determined control and the determined difficulty;
calculate revised evaluation using the original evaluation, the determined difficulty, and the calculated learning progress; and
update the policy using the observation information, the determined control, the determined difficulty, and the revised evaluation.

2. The learning device according to claim 1, wherein
the one or more processors are further configured to execute the software instructions to determine the control to be applied to the target system and the difficulty to be set to the target system further using the learning progress.

3. The learning device according to claim 1, wherein
the higher the learning progress and the lower the determined difficulty, the one or more processors are further configured to execute the software instructions to calculate smaller values of the revised evaluation, for the original evaluations whose values are the same.

4. The learning device according to claim 1, wherein
the lower the learning progress and the higher the determined difficulty, the one or more processors are further configured to execute the software instructions to calculate smaller values of the revised evaluation, for the original evaluations whose values are the same.

5. A learning method, implemented by a processor, learning a policy that determines control contents of a target system, comprising:
determining control to be applied to the target system and difficulty to be set to the target system using observation information regarding the target system and difficulty corresponding to a way of state transition of the target system and how likely it is to be rated highly related to the contents of the control, according to the policy;
calculating learning progress of the policy using a plurality of original evaluations of states before and after transition of the target system and the determined control, according to the determined control and the determined difficulty;
calculating revised evaluation using the original evaluation, the determined difficulty, and the calculated learning progress; and
updating the policy using the observation information, the determined control, the determined difficulty, and the revised evaluation.

6. A non-transitory computer readable recording medium storing a learning program for learning a policy that determines control contents of a target system, wherein
the learning program causes a computer to execute:
a process of determining control to be applied to the target system and difficulty to be set to the target system using observation information regarding the target system and difficulty corresponding to a way of state transition of the target system and how likely it is to be rated highly related to the contents of the control, according to the policy;
a process of calculating learning progress of the policy using a plurality of original evaluations of states before and after transition of the target system and the determined control, according to the determined control and the determined difficulty;
a process of calculating revised evaluation using the original evaluation, the determined difficulty, and the calculated learning progress; and
a process of updating the policy using the observation information, the determined control, the determined difficulty, and the revised evaluation.

7. The learning device according to claim 2, wherein
the higher the learning progress and the lower the determined difficulty, the one or more processors are further configured to execute the software instructions to calculate smaller values of the revised evaluation, for the original evaluations whose values are the same.

8. The learning device according to claim 2, wherein
the lower the learning progress and the higher the determined difficulty, the one or more processors are further configured to execute the software instructions to calculate smaller values of the revised evaluation, for the original evaluations whose values are the same.

9. The learning device according to claim 3, wherein
the lower the learning progress and the higher the determined difficulty, the one or more processors are further configured to execute the software instructions to calculate smaller values of the revised evaluation, for the original evaluations whose values are the same.
